(19) United States
(12) Patent Application Publication
(10) Pub. No.: US 2018/0165165 A1
(43) Pub. Date: Jun. 14, 2018

(54) COMMIT BASED MEMORY OPERATION IN A MEMORY SYSTEM

(71) Applicant: Hewlett Packard Enterprise Development LP, Houston, TX (US)

(72) Inventors: Luis Miguel Vaquero Gonzalez, Bristol (GB); Suksant Sae Lor, Bristol (GB)

(21) Appl. No.: 15/572,996

(22) PCT Filed: Jul. 31, 2015
(86) PCT No.: PCT/EP2015/067690

§ 371 Date: Nov. 9, 2017

(51) Int. Cl. G06F 11/14; G06F 9/46

(52) U.S. Cl. CPC G06F 11/1474; G06F 9/467

(57) ABSTRACT

A group of memory modules in a memory system receives a memory operation instruction comprising instructions on a memory operation and sends votes on the possibility to perform the memory operation to a memory coordinator module. The memory coordinator module receives votes and establishes a list of memory modules which have voted positively. The memory coordinator module verifies that the list of memory modules comprises all the memory modules in the group and that there is not another memory coordinator module detected by the memory coordinator module, instructs all the memory modules in the group to commit to the memory operation.

### BACKGROUND

Some computing systems use memory systems comprising a plurality of interconnected memory components, for example memory networks or memory fabrics. The memory components may be distributed to different locations, with some memory components being located close to the computing systems and some other memory components being located at remote locations, or co-located in various numbers, as desired.

### BRIEF DESCRIPTION OF THE DRAWINGS

The following detailed description references the drawings, wherein:

FIG. 1 is a flowchart of an example of a method for performing a memory operation;

FIG. 2 is a simplified schematic of an example memory system; and

FIG. 3 is a flowchart of an example of a method for performing a memory operation.

### DETAILED DESCRIPTION

The following detailed description refers to the accompanying drawings. Wherever possible, the same reference numbers are used in the drawings and the following description to refer to the same or similar parts. While several examples are described in this document, modifications, adaptations, and other implementations are possible. Accordingly, the following detailed description does not limit the disclosed examples. Instead, the proper scope of the disclosed examples may be defined by the appended claims.

In a memory system comprising a plurality of interconnected memory components, the management of the memory resources may be implemented by treating the memory as if it is a routable resource. This involves treating memory addresses in a manner similar to how IP addresses are used in an IP network, so as to form a memory network.

These memory systems may manage the plurality of memory components as a single memory space. The memory space may be made available as a memory resource to a single computing node or it may be implemented as a shared memory.

It is to be understood that in the present document the expressions “memory” and “storage” (and related expressions) may be used as synonyms: that is, absent other qualifying text these expressions do not convey information regarding the transience or persistence of the data held.

In an arrangement of a plurality of memory components, a connection or a disconnection of the memory component can occur at any time: there is volatility in the arrangement of memory components of a memory system.

The memory components may form a memory space seen by the computing system as a single and uniform memory space. The memory components may thus use gateways and internal routers among the memory components to perform the operations requested by the computing system.

Optical interconnections may be used to interconnect the memory components to provide reduced latencies and high bandwidths, even for remotely located memory components.

Partitions of memory components may be implemented in the aforementioned memory systems. A partition may comprise a group or a duster of individual memory components and the memory system may comprise several partitions which can also be considered as parts of the memory systems. Also, it should be noted that the memory system can have a dynamic structure wherein the different partitions can be temporarily disconnected from the memory system. This can happen if a device comprising the memory components of a partition is disconnected.

A technical challenge arises in the management of memory operations in a partitioned memory system.

A memory operation can comprise a transaction that affects a portion of memory in several memory components. Such a memory operation can also be referred to as a distributed transaction or as a dynamic transaction. Management of a distributed transaction may involve coordination between the memory components participating in the transaction and, in particular, may involve management of whether the overall transaction commits or aborts (is rolled back) at all memory components.

In a partitioned memory system, the lack of synchronization between the partitions can lead to inconsistencies between the memory components asked to perform a same memory operation.

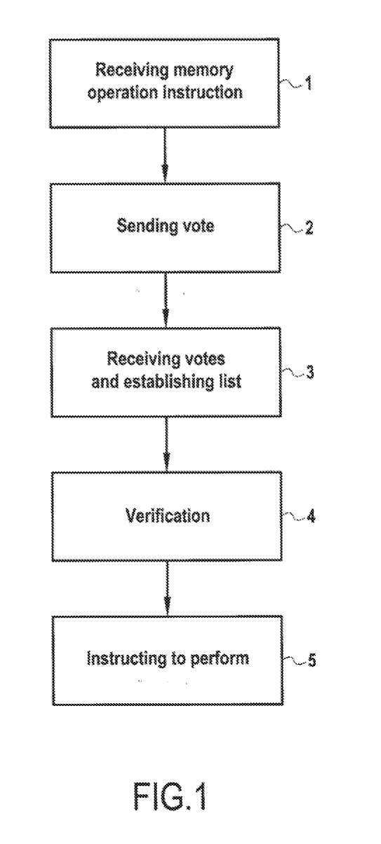

Referring now to the drawings, a flowchart of a method for performing a memory operation (such as a distributed or dynamic transaction) addresses these technical challenges and is represented on FIG. 1.

The method of FIG. 1 is implemented by memory modules of a memory system comprising a plurality of memory modules. Among the memory modules, several memory modules act as memory coordinator modules. Also, the memory modules (including the memory coordinator modules) are all considered to be able to communicate with each other (for example using some of the memory modules as routers and switches). Also, it should be noted that the memory modules may not have knowledge of any partitioning of the memory system.

The method of FIG. 1 comprises receiving (reference 1) a memory operation instruction comprising instructions on a memory operation, and this receiving is done by a group of memory modules in the memory system. The memory operation instruction comprises instructions on the actual memory operation (for example which part of the memory to update), and additional information such as a pre-established list of memory coordinator modules. The memory modules of the group may thus establish a list of memory coordinator modules to be used for the transaction (for example a list of identifiers of the memory coordinator modules). Also, the memory operation instruction comprises the list of memory modules in the group of memory modules which are expected to perform the memory operation.

The memory operation instruction is provided by a computing system which may have knowledge of at least:
Which memory modules are coordinator modules,
Which memory modules it wants to participate to the memory operation,
Which memory coordinator modules it wants to act as coordinators for the memory operation.

The memory coordinator modules of the memory system are also memory modules of the memory system. The memory coordinator modules may therefore receive the same memory operation instruction because they can belong to the group of memory modules, or because they are to be used by for the memory operation.

Each memory module of the group of memory modules then sends (reference 2) a vote on the possibility to perform the memory operation to a memory coordinator module of the memory system. The vote can comprise information indicating that the memory module is individually willing to commit to the memory operation or to perform the memory operation or information indicating that the memory module is not individually willing to commit to the memory operation.

If the list of memory coordinator modules to be used for the transaction of each memory module comprises several memory coordinator modules, then each memory module of the group of memory module will send its vote to every memory coordinator module. Also, in the present example the memory modules may not be allowed to change their vote after sending this vote to at least one memory coordinator module. In the case where change is not allowed a situation is avoided in which conflicting information is held by two memory coordinator modules.

It should be noted that if a memory coordinator module belongs to the group of memory modules, then sending its own vote includes memorizing this vote and also sending this vote to other memory coordinator modules if this memory coordinator module has knowledge of other memory coordinator modules.

The memory coordinator module (or modules) then receives (reference 3) the votes and establishes a list of memory modules which have voted positively on the possibility to perform the transaction. It should be noted that if the memory coordinator module receives a vote indicating that a memory module cannot perform the memory operation (negative vote), then the memory coordinator module aborts the memory operation and instructs all the memory modules of the group of memory modules to abort the memory operation.

It should be noted that a memory module can send a vote indicating that it cannot perform the memory operation if it considers that a requirement for performing the memory operation is not reached or if a condition is encountered which makes the memory module consider that it cannot perform the memory operation.

If the coordinator module has only received votes from memory module which individually commit to the memory operation, a list of these modules is established, for example by establishing a list of identifiers of these memory modules (this list can comprise the identifier of the memory coordinator module).

Afterwards, the memory coordinator module verifies (reference 4) that the list of memory modules which have voted positively comprises all the memory modules in the group.

Another verification comprises verifying that there is not another memory coordinator module detected by the memory coordinator module.

If there is no other memory coordinator module detected by the memory coordinator module carrying out the method and if the list comprises all the memory modules of the group of memory modules, then the memory coordinator module may instruct all the memory modules in the group to commit to the memory operation (reference 5).

It should be noted that the above described example method for performing a memory operation provides a memory operation performed in a secure manner. The memory operation of the above described example can be considered by the skilled man as an atomic operation. This results from the fact that the operation is carried out if all the memory modules which are expected to carry out the operation commit to doing the operation, and from the fact that before instructing all the memory modules to commit to the operation, it is verified that only one memory coordinator module will instruct the memory modules.

Also, the above described example does not require that the memory coordinator modules have knowledge of a partitioning of the memory modules.

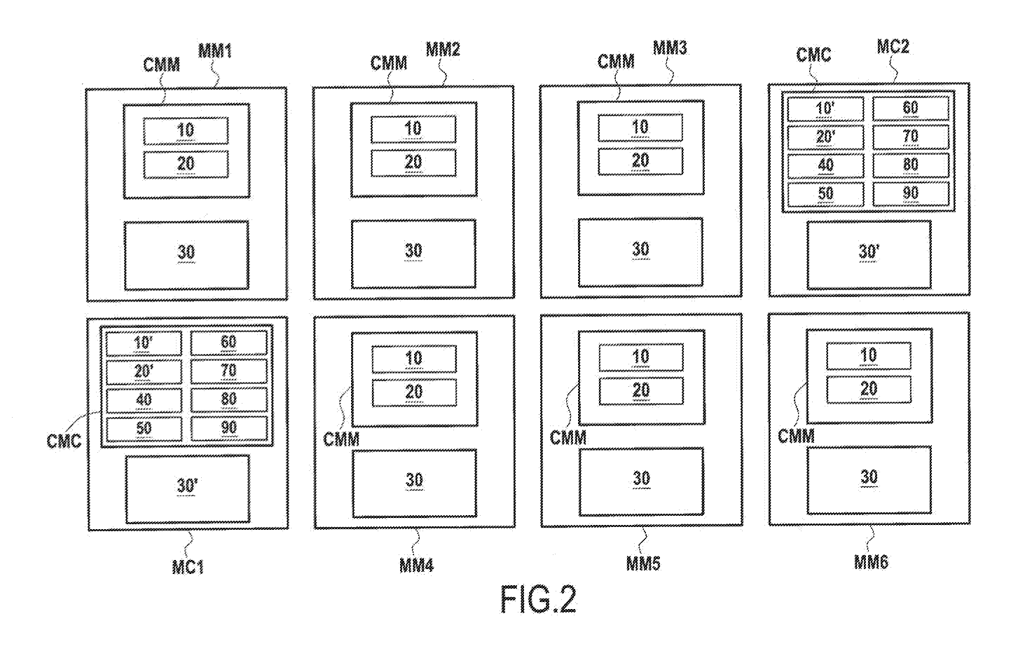

A memory system is represented on FIG. 2. This memory system can perform the method of the example described in reference to FIG. 1.

The modules illustrated in FIG. 2 are not limited having regard to the memory technology/hardware used to implement the physical storage of data. Further, the functionality of each module may be implemented using a combination of hardware and programming. Hardware of each module may include a processor and an associated machine-readable storage medium storing instructions/code. The programming is instructions or code stored on the machine-readable storage medium and executable by the processor to perform the designated function. Furthermore, in FIG. 2 and other Figures described herein, different numbers of components or entities than depicted may be used.

The memory system of FIG. 2 comprises a plurality of memory modules MM1, MM2, MM3, MC2, MC1, MM4, MM5 and MM6.

Memory modules MM1, MM2, MM3, MM4, MM5 and MM6 can only act as memory modules. Memory modules MC1 and MC2 can act as memory modules and they can perform the functions of a memory coordinator module. These memory modules can be arranged in different partitions, for example a partition comprising memory coordinator module MC1 and a partition comprising memory coordinator module MC2.

The memory modules MM1, MM2, MM3, MC2, MC1, MM4, MM5 and MM6 can differ from each by at least one of: storage capacity, manufacturer, storage technology, and memory protocol. These memory modules may also be located in same or different locations.

Memory modules MM1, MM2, MM3, MM4, MM5 and MM6 each comprise a controller CMM comprising instructions 10 to receive memory operation instruction. The controllers CMM also comprise instructions 20 to send votes on the possibility to perform the memory operation to memory coordinator module MC1 or to memory coordinator module MC2. Memory modules MM1, MM2, MM3, MM4, MM5 and MM6 also comprise a memory 30 which is non-volatile and may be, for example, an Electrically-Erasable Programmable Read-Only Memory (EEPROM), a storage drive, an optical disc, and so forth.

Memory coordinator modules MC1 and MC2 each comprise a memory 30′ and a controller CMC comprising instructions 10′ to receive a memory operation instruction: the memory coordinator modules receive it because they can be memory modules expected to perform the memory operation or because they will act as memory coordinator module for the memory operation. The memory 30′ may be, for example, an Electrically-Erasable Programmable Read-Only Memory (EEPROM), a storage drive, an optical disc, and so forth.

Thus, the controller CMC also comprises instructions 20′ to send votes on the possibility to perform a memory operation.

Additionally, the controller CMC comprises instructions 40 to start a counter which will verify that a predetermined period has not expired before instructing all the memory modules in the group to commit to the memory operation. The memory coordinator module will abort the memory operation if the counter reaches the predetermined period. Consequently, performing a memory operation using the memory coordinators cannot lead to a stuck system waiting to receive a vote from a memory module. This prevents blocking the resources of the system.

The controller CMC also comprises instructions 50 to receive votes on the possibility to perform the memory operation, establish a list of memory modules which have voted positively on the possibility to perform the memory operation, instructions 60 to verify that the list of memory modules which have voted positively comprises all the memory modules in the group, instructions 70 to verify that there is not another memory coordinator module detected by the memory coordinator module, instructions 80 to choose a single memory coordinator module if another memory coordinator module is detected. This chosen memory coordinator module is chosen among the memory coordinator modules that participate to the memory operation. In other words, only a memory coordinator module which has received the memory operation instruction will participate in the choosing with other memory coordinator modules which have been detected.

In some examples, when the chosen memory coordinator module considers that it cannot send an instruction to commit to the transaction, the chosen memory coordinator module may not immediately instruct all the memory modules to abort the memory operation. The memory coordinator module can instruct other memory coordinator modules which participated to the choosing of the memory coordinator module that it cannot send the final commitment, because another memory coordinator module may still be able to send the final commitment.

The controller CMC comprises instructions 90 to instruct all the memory modules in the group to commit to the memory operation if the list of memory modules which have committed comprises all the memory modules in the group and if there is not another memory coordinator module detected by the memory coordinator module.

It should be noted that the instructions of the controllers can be stored in a machine-readable storage medium which may be any electronic, magnetic, optical, or other physical storage device that stores executable instructions. Such machine-readable storage medium may be, for example, Random Access Memory (RAM), an Electrically-Erasable Programmable Read-Only Memory (EEPROM), a storage drive, an optical disc, and the like.

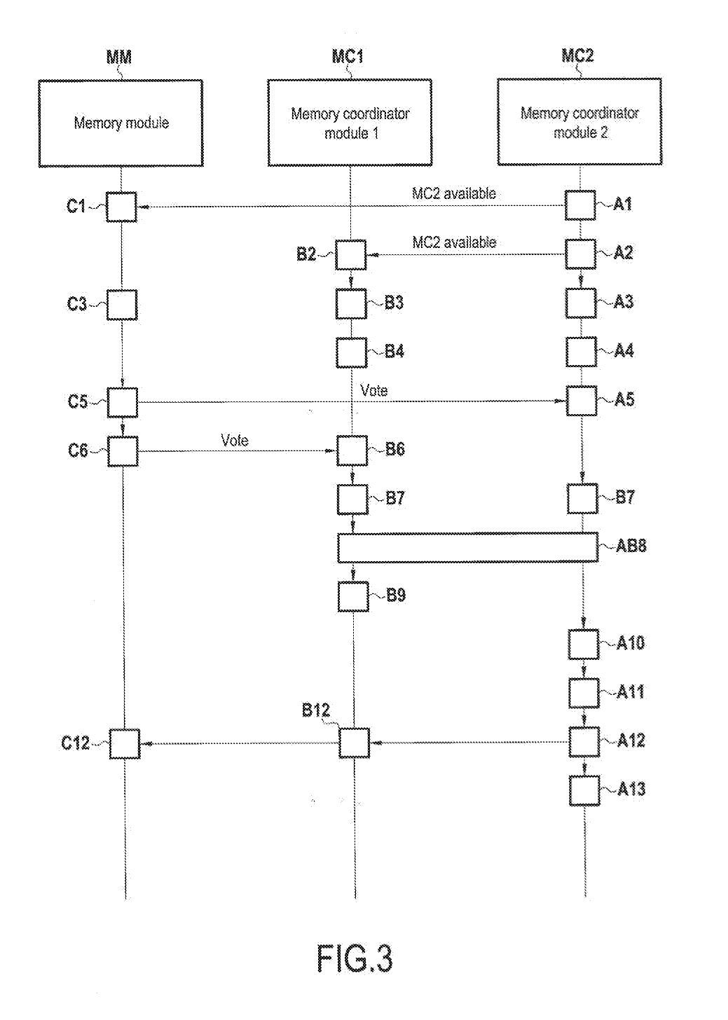

FIG. 3 is a flowchart of an example of a method for performing a memory operation in a memory system such as the one described in reference to FIG. 2. In this example, only one memory module MM is represented for the sake of simplicity. Two memory coordinator modules MC1 and MC2 are also represented and these modules are present in order to indicate which module performs which function.

Firstly, the memory coordinator module MC2 regularly sends information on its availability for the transaction to a duster of memory modules of the plurality of memory modules (reference A1 on FIG. 3). The cluster of memory modules can be all the memory modules in the partition comprising the memory coordinator module MC2.

In some memory systems, memory components transmit “presence” signals as part of an existing protocol, for example, a protocol associated with memory addressing. In the case of applying the present example method to such memory systems, bandwidth can be saved by using the existing “presence” signals to alert memory modules about the memory coordinator modules, rather than sending a dedicated signal for the latter purpose.

The availability information is received (reference C1) by the memory module MM, and it is also received (reference B2) by the memory coordinator module MC1: the memory coordinator module MC1 and the memory module MM are in the partition of the memory coordinator module MC2, and the memory coordinator module MC2 may only send its availability information to the modules present in its partition.

It should be noted that one of the memory coordinator modules MC1 or MC2 may be a backup memory coordinator module of the other memory coordinator module.

Three simultaneous receptions A3, B3 and C3 of a memory operation instruction are then carried out respectively by the memory coordinator MC2, the memory coordinator MC1 and by the memory module MM. The memory operation instruction can comprise instructions on the actual memory operation (for example which part of the memory is involved), and in this example additional information such as a pre-established list of memory coordinator modules indicating to the memory module MM that the memory coordinator module MC1 is to be used for this memory operation.

Receiving the memory operation instruction may cause a memory module to perform a verification that is can perform the actual memory operation. It can also cause the memorization of the instruction and/or of data deduced from the memory operation instruction. This way, if an instruction to abort the memory operation is received by the memory module, it can ensure that nothing in the memory operation is performed.

In A4 and B4, a counter is started for counting a predetermined duration. An indication of the value to set for this duration may be received in the memory operation instruction.

The memory module MM sends in CS its vote on the possibility to perform the memory coordinator module MC2 which receives it in A5 (individual commitment). The memory module MM sends the same vote in C6 to the memory coordinator module MC1 which receives it in B6.

The two memory coordinator modules MC1 and MC2 then establish a list of memory modules which have voted positively (references B7 and A7), and if the two memory coordinator modules are expected to perform the memory operation, they add themselves to their respective lists.

At this stage, both memory coordinator modules have knowledge of the other memory coordinator module: MC1 has received information on the availability of MC2 directly from MC2 and MC2 has received the memory operation instruction indicating that MC1 is to be used.

A single memory coordinator module is then chosen (reference AB8). This selection comprises the memory coordinator modules sending their respective lists of memory modules which have voted positively to each other, and comparing these lists to determine which memory coordinator module has the longest list.

It should be noted that by sending their respective lists to each other, it is possible to merge the two lists into a single list which can be more complete than either of the two lists. This also implies that this single list is memorized in the two memory coordinator modules, keeping the information in the system even if one of them is disconnected. This improves the security of the memory operation. Also, merging the lists allows to perform the memory operation even if communication failures occur because if a memory module was only able to send its vote to a single memory coordinator module, then another memory coordinator module can obtain the vote of this memory module through the merging.

If the chosen memory coordinator module considers that it cannot send an instruction to commit to the transaction, the chosen memory coordinator module may not immediately instruct all the memory modules to abort the memory operation. The memory coordinator module can instruct other memory coordinator modules which participated to the choosing of the memory coordinator module that it cannot send the final commitment, because another memory coordinator module may still be able to send the final commitment. It should be noted that the memory coordinator which could not send the final commitment is excluded from being a potential single memory coordinator module again, if a new single memory coordinator module is chosen.

Because the other memory coordinator modules which participated in the choosing of the single memory coordinator module have memorized the single merged list, any such memory coordinator module can still instruct to perform the memory operation.

This improves the reliability of the memory operation, for example if a memory coordinator module cannot locate a memory address in a memory module, or if communication is not possible between a memory coordinator module and a memory module expected to perform the memory operation.

Alternatively, choosing a single memory coordinator module comprises taking a parameter of the memory coordinators modules into account, for example the storage capacity of the memory coordinator module.

It is considered that the memory coordinator module MC2 is chosen. The memory coordinator module MC1 then reverts to being a memory module (reference B9) and the memory coordinator module MC2 is the single memory coordinator module.

The memory coordinator module MC2 then verifies in A10 that its list of memory modules which have voted positively (which can be a merged single list of memory modules) is complete and that it comprises all the memory modules of the group of memory modules.

The memory coordinator module MC2 then decides (reference A11) that it can instruct the memory modules to commit to the memory operation. This instruction is then sent (reference A12) and received by the memory coordinator module MC1 (B12) and by the memory module (C12) and all three modules perform the memory operation.

Finally, the memory coordinator module MC2 can determine that the predetermined duration has expired (A13).

Each of the examples described above of memory system or of method for performing a memory operation can perform memory operations even if one memory coordinator module is unavailable, or if communication failures occur.

1. A method comprising:
receiving, by a group of memory modules in a memory system, a memory operation instruction comprising instructions on a memory operation,
sending, by each memory module of the group of memory modules, a vote on the possibility to perform the memory operation, to a memory coordinator module of the memory system,
receiving, by the memory coordinator module, votes sent by memory modules and,
establishing, by the memory coordinator module, a list of memory modules which have voted positively on the possibility to perform the memory operation,
verifying, by the memory coordinator module, that the list of memory modules comprises all the memory modules in the group and that there is not another memory coordinator module detected by the memory coordinator module, and
instructing, by the memory coordinator module, all the memory modules in the group to commit to the memory operation responsive to determining that the list of memory modules comprises all the memory modules in the group and responsive to determining that there is not another memory coordinator module detected by the memory coordinator module.

2. A method in accordance with claim 1, wherein the coordinator module verifies that a predetermined period has not expired before instructing all the memory modules in the group to commit to the memory operation.

3. A method in accordance with claim 1, wherein each memory module of the group of memory modules establishes a list of memory coordinator modules to be used for the memory operation and sends votes on the possibility to perform the memory operation to each memory coordinator module of the list of memory coordinator modules to be used for the memory operation.

4. A method in accordance with claim 3, wherein each memory module sends the same vote to each memory coordinator module.

5. A method in accordance with claim 1, wherein responsive to the vote from a memory module received by a memory coordinator module indicating that the memory module cannot perform the memory operation, the memory coordinator module aborts the memory operation and sends abort information to every memory module in the group of memory modules.

6. A method in accordance with claim 1, wherein each memory coordinator module regularly sends information on its availability to a cluster of memory modules of the plurality of memory modules.

7. A method in accordance with claim 6, wherein each memory module of the group of memory modules establishes a list of memory coordinator modules to be used for the memory operation based on the received information on the availability of memory coordinator modules.

8. A method in accordance with claim 1, wherein responsive to the memory coordinator module detecting another memory coordinator module, the memory coordinator modules choose a single memory coordinator module for acting as memory coordinator module for the memory operation, and the memory coordinator module which was not chosen acts as a memory module.

9. A method in accordance with claim 8, wherein the memory coordinator modules send each other their lists of memory modules which have voted positively on the possibility to perform the memory operation.

10. A method in accordance with claim 9, wherein choosing a single memory coordinator module comprises choosing the memory coordinator module having the longest list of memory modules.

11. A method in accordance with claim 9, wherein the single memory coordinator module merges the lists of memory modules into a single list of memory modules.

12. A method in accordance with claim 8, wherein choosing a single memory coordinator module comprises taking a parameter of the memory coordinators modules into account.

13. A method in accordance with claim 3, wherein establishing the list of memory coordinator modules to be used for the memory operation is based on a pre-established list of memory coordinator modules comprised in the memory operation instruction.

14. A memory system comprising a plurality of memory modules, wherein
a group of modules of the plurality of memory modules each comprise a controller to receive a memory operation instruction comprising instructions on a memory operation, and to send a vote on the possibility to perform the memory operation to a memory coordinator module of the plurality of memory modules,
the plurality of memory modules comprising at least two memory coordinator modules, and,
each memory coordinator module comprising a controller to receive votes, establish a list of memory modules which have voted positively on the possibility to perform the memory operation, verify that the list of memory modules comprises all the memory modules in the group and that there is not another memory coordinator module detected by the memory coordinator module, and instruct all the memory modules in the group to commit to the memory operation responsive to the list of memory modules comprising all the memory modules in the group and responsive to determining that there is not another memory coordinator module detected by the memory coordinator module.

15. A memory system according to claim 14, wherein memory modules of the plurality of memory modules differ from each other by at least one of: storage capacity, manufacturer, storage technology, and memory protocol.
